(19) United States
(12) Patent Application Publication
(10) Pub. No.: US 2024/0116811 A1
(43) Pub. Date: Apr. 11, 2024

(54) CEMENTITIOUS COMPOSITES VIA CARBON-BASED NANOMATERIALS

(71) Applicant: C-CRETE TECHNOLOGIES LLC, Houston, TX (US)

(72) Inventors: ROUZBETH SHAHSAVARI, Houston, TX (US); MAHESH BHATT, Houston, TX (US)

(21) Appl. No.: 17/769,196

(22) PCT Filed: Oct. 14, 2020
(86) PCT No.: PCT/US2020/055634

§ 371 Date: Apr. 14, 2022

Related U.S. Application Data
(60) Provisional application No. 62/914,867, filed on Oct. 14, 2019.

(51) Int. Cl. C04B 14/02; C04B 20/02; C04B 40/00

(52) U.S. Cl. CPC C04B 14/026; C04B 20/023; C04B 40/0039; C04B 2201/50

(57) ABSTRACT

Novel composites having improved performance such as compressive and/or tensile strengths are formed from carbon-based nanomaterials and a binder. Sheared carbon-based nanomaterial in solution is typically mixed with a binder and then cured. The composites may have several improved properties such as higher compressive strength, tensile strength, lower shrinkage, and modified viscosity which are greater than the binder alone.

### CROSS-REFERENCE TO RELATED APPLICATIONS

The present application claims priority to U.S. provisional application 62/914,867 filed Oct. 14, 2019 the contents of which are incorporated herein by reference.

### FIELD OF THE INVENTION

The present application relates generally to composites and methods of making cementitious composites with improved properties such as, for example, higher compressive strength, tensile strength, Young's modulus, durability, thermal and/or electrical conductivity, a lower shrinkage and/or a modified viscosity using various forms of additive carbon including graphene and coal-based materials.

### BACKGROUND AND SUMMARY

Concrete and cement are one of the most used materials in the world for construction of, for example, buildings, roads, and the like. What is needed is binder formulations and methods of making them wherein the cementitious composite has improved properties.

Advantageously, the instant application provides composites with improved properties such as increased compressive and tensile strengths that can be made efficiently and effectively with only small amounts of additives. Accordingly, such composites may be made cost-effectively using carbon-based nanomaterials made from a wide variety of carbon starting materials including waste products such as plastic.

In one embodiment, the present application pertains to a cementitious composite comprising graphene with at least 0.01% by weight of cement. Advantageously, the composite may be characterized by (a) a compressive strength of at least about 15% greater than a compressive strength of the composite in absence of graphene; or (b) a tensile strength of at least about 15% greater than a tensile strength of the composite in the absence of graphene; or (c) both (a) and (b).

In one embodiment, the present application pertains to concrete which comprises at least cement, sand, and gravel and water and where at least 0.01% by weight of the its cement is graphene. Advantageously, the composite may be characterized by (a) a compressive strength of at least about 15% greater than a compressive strength of the concrete in absence of graphene; or (b) a tensile strength of at least about 15% greater than a tensile strength of the concrete in the absence of graphene; or (c) both (a) and (b).

In another embodiment, the present application pertains to a method for making a composite having increased performance comprising first (a) dispersing carbon based material in water and (b) mixing this treated water with cement or cement, sand and gravel. The mixture is then cured to form a high performance composite.

In another embodiment, the present application pertains to a method for making a composite having increased strength comprising first (a) dispersing carbon based material in water using less than 2% surfactant and (b) mixing this treated water with cement or cement, sand and gravel. The mixture is then cured to form a high strength composite.

In another embodiment, the present application pertains to a method for making a composite having increased performance comprising dispersing carbon based material as an additive in a wet (not cured) cement. The mixture is then mixed and cured to form a high performance composite.

In another embodiment, the present application pertains to a method for making a concrete having increased performance comprising dispersing carbon based material as an additive in a wet (not cured) concrete mortar. The mixture is then mixed and cured to form a high performance concrete.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 shows 7-day compressive strength of 2″ Portland cement cubes (type I/II) reinforced by turbostratic graphene (or flash graphene).

FIG. 2 shows 28-day compressive strength of 2″ Portland cement cubes (type I/II) reinforced by turbostratic graphene.

FIG. 3 shows 7-day compressive strength of 2″ Portland cement cubes (type I/II) reinforced by turbostratic graphene made from HDPE.

FIG. 4 shows 7-day compressive strength of 2″ Portland cement cubes (type I/II) reinforced by turbostratic graphene made from various feedstocks.

FIG. 5 shows 28-day compressive strength of 4″×8″ concrete cylinders with two different types of graphene.

FIG. 6 shows representative 7 day results, demonstrating increase in compressive strength of 1″ cube OPC composites, flyash composites, and slag composites comprised of various wt % of graphene I (turbostratic graphene obtained from carbon black derived from pyrolyzed rubber tires).

FIG. 7 shows representative 7 day results, demonstrating increase in compressive strength of 1″ cube OPC composites, flyash composites, and slag composites comprised of various wt % of graphene II (turbostratic graphene obtained from waste plastics derived pyrolysis ash).

FIG. 8 shows representative 7 day results, demonstrating increase in compressive strength of 1″ cube OPC composites, flyash composites, and slag composites comprised of various wt % of graphene III (turbostratic graphene obtained from shredded raw rubber tires with 5% carbon black as conductive filler).

FIG. 9 shows representative 28 day results, demonstrating increase in compressive strength of 4″×8″ concrete cylinders with OPC, flyash, or slag binders comprised of optimal 2 wt % of graphene I (turbostratic graphene obtained from carbon black derived from pyrolyzed rubber tires).

FIG. 10 shows representative 28 day results, demonstrating increase in compressive strength of 4″×8″ concrete cylinders with OPC, flyash, or slag binders comprised of optimal wt % of graphene II (turbostratic graphene obtained from waste plastics derived pyrolysis ash).

FIG. 11 shows representative 28 day results, demonstrating increase in compressive strength of 4″×8″ concrete cylinders with OPC, flyash, or slag binders comprised of optimal wt % of graphene III (turbostratic graphene obtained from shredded raw rubber tires with 5% carbon black as conductive filler).

FIG. 12 shows representative 28 day results, demonstrating >20% increase in compressive strength of concrete samples with respect to the control concrete sample.

FIG. 13 shows direct conversion of carbon feedstock (e.g. coal) to water soluble graphene/graphitic structures for reinforcing cementitious composites.

FIG. 14(a)-(b) show representative results for 7-day compressive strength of 2″ cement cubes reinforced by mainly bituminous coal, b-coal in FIG. 14(a) and calcined pet coke in FIG. 14(b).

FIGS. 14(c)-(d) show compressive strength of various concrete cylinders at 7 days in FIG. 14(c) and at 28 days in FIG. 14(d).

### DETAILED DESCRIPTION OF THE INVENTION

The general inventive concept is described more fully below with reference to the accompanying drawings, in which exemplary embodiments of the present invention are shown. As those skilled in the art would realize, the described embodiments may be modified in various different ways, all without departing from the spirit or scope of the present invention. The present invention should not be construed as being limited to the embodiments. Accordingly, the drawings and description are to be regarded as illustrative in nature to explain aspects of the present invention and not restrictive. Like reference numerals in the drawings designate like elements throughout the specification, and thus their description have not been repeated.

### Increased Strength Composite and General Method

In one embodiment, the application pertains to a composite comprising cement and carbon-based material. The type of cement used in the composites of the application is not particularly critical so long as its properties such as compressive strength and/or tensile strength are capable of being increased with the addition of carbon-based material as taught herein. The type of cement employed may vary depending upon the specific use of the cement (such as cement Type I, II, III, IV, V, calcium aluminate-based cement, calcium sulfate-based cement, calcium sulfoaluminate-based cement, pozzolan-based cement, limestone calcined clay cement, class H and G cements, white cement, activated wastes as cement such as alkali activated flyash C, Flyash F, bottom ash, boiler slag, granulated blast furnace slag, bauxite residues, coal combustion residues, thermo activated clay, or any combination of these), the amount and type of carbon-based material to be added, the desired properties, and the method of making the composite.

In one embodiment, the application pertains to a composite comprising concrete and carbon-based material. The type of concrete used in the composites of the application is not particularly critical so long as its properties such as compressive strength and/or tensile strength are capable of being increased with the addition of carbon-based material as taught herein. The type of concrete employed may vary depending upon the specific use of the concrete, the amount and type of carbon-based material to be added, the desired properties, and the method of making the composite.

As used herein “binder” or “cement” includes typical cementitious materials made from cement Type I, II, III, IV, V, calcium aluminate-based cement, calcium sulfate-based cement, calcium sulfoaluminate-based cement, pozzolan-based cement, limestone calcined clay cement, class H and G cements, white cement, activated wastes as cement such as alkali activated flyash C, Flyash F, bottom ash, boiler slag, granulated blast furnace slag, bauxite residue, coal combustion residues, thermo activated clays, or any combination of these.

As used herein concrete includes typical concrete materials made from above-described binder or cement with aggregate and water based mixtures, as well as concrete with additives such as fumed silica, air entrainers, plasticizers, retarders, and the like.

The carbon based nanomaterials may also be referred to herein as “graphene” and may be from virtually any carbon source. Such carbon based nanomaterials or graphenes used may include, for example, traditional graphene and its variations as described herein, as well as graphene that takes the form of quantum dot particles instead of large sheets. In some instances, the carbon based nanomaterials may include an oxidized form of a carbon based nanomaterial described herein. Some examples include an oxidized form of coal, coke, shungite, asphaltenes, acetylene black, petroleum coke. In some cases, the graphene may comprises less than 10 layers or comprises more than 10 layers and may comprise graphite. In some embodiments the composite of claim 1, wherein the graphene comprises turbostratic graphene or flash graphene as described in WO2020051000 (Application PCT/US2019/04796) which is incorporated herein by reference. In some embodiments the graphene comprises bernal stacked graphene or nanoplatelets, or tubostratic graphene or the combination thereof. In some embodiments, turbostratic graphene is at least 90 wt % of the bulk graphene material produced.

The graphene may be derived from any suitable source. Such sources include, for example, feces, plastics, vinyl polymers, condensation polymers, step-growth polymers, chain-growth polymers, living polymers, rubbers, humic acid, carbohydrates, rice powder, food waste, food, coal, organic waste, organic material, bituminous coal, coke, shungite, asphaltenes, acetylene black, carbon black, petroleum coke, oil, petroleum products, carbon from the stripping of the non-carbon atoms off of natural gas or oil or carbon dioxide, wood, cellulose, leaves, branches, grass, biomass, animal carcasses, fish carcasses, proteins, and mixtures thereof. The type of coal is not particularly limited and includes, for example, a coal selected from anthracite, bituminous, sub-bituminous, lignite, or a mixture thereof. Similarly, the type of plastic is not limited and includes, for example, a plastic selected from high-density polyethylene (HDPE), low-density polyethylene (LDPE), polyvinyl chloride (PVC), polypropylene (PP), polyacrylonitrile (PAN), Polyethylene terephthalate (PET), or a mixture thereof.

In some embodiments, there are heteroatoms present in the feedstock to afford a doped or heteroatom-containing graphene product. In some embodiment, the heteroatoms are selected from a group consisting of nitrogen, phosphorous, phosphines, phosphates, boron, metals, semimetals, melamine, aminoborane, melamine-formaldehyde resin, and mixtures thereof.

In some embodiments, there are chemical covalent functionalization of turbostratic graphene, wherein the functionalization atom is selected from a group consisting of oxygen, carbon, metals, sulfur, phosphorous, non-metals, metalloids, and combinations thereof.

In some embodiments, there are chemical non-covalent functionalization of turbostratic graphene by one or more of surfactants, proteins, polymers, aromatics, small organic molecules, gases, groundwater contaminants, biological cells, microorganisms, polychlorinated biphenyls, perchlorates, and borates.

In some embodiments, the (a) turbostratic graphene comprises a plurality of graphene sheets, and (b) the graphene sheets comprise predominately sp2-hybridized carbon atoms.

In some embodiments, the graphene sheets comprise at least 70 atom % sp2-hybridized carbon atoms.

In some embodiments the graphene is a mixture of two or more of any of the types of graphene described herein.

Generally, the graphene comprises an amount of a composition (such as a sheared graphene dispersion in water) that is sufficient such that a composite made therefrom may be characterized by an improvement in one or more properties such as (a) a compressive strength of at least about 15%, or at least about 20%, or at least about 25%, or at least about 30%, or at least about 35%, or at least about 40%, or at least about 45%, or at least about 50%, or at least about 60% or even greater than a compressive strength of the cementitious composite in absence of graphene; or (b) a tensile strength of at least about 15%, or at least about 20%, or at least about 25%, or at least about 30%, or at least about 35%, or at least about 40%, or at least about 45%, or at least about 50%, or at least about 60% or even greater than a tensile strength of the cementitious composite in the absence of graphene; or (c) any percentage of (a) listed above and any percentage of (b) listed above. As used herein compressive strength is measured by a Forney VFD (Variable Frequency Drive) automatic machine with dual load cells for maximum accuracy. The tensile strength is measured by split tensile (Brazilian) test to measure the tensile strength of the cylinders. The specific jigs hold the cement or concrete cylinders so that the uniaxial compressive force applied to the center lines of the bottom and top surface of the samples causes the tensile stress between the points of contact.

The amount of graphene in the composite may vary depending upon the type and amount of cement, concrete, the type and amount of graphene, and the desired properties of the composite. Generally, the amount of graphene in the composite is at least about 0.005%, or at least about 0.01%, or at least about 0.03%, or at least about 0.05%, or at least about 0.1%, or at least about 0.50%, or at least about 1%, or at least about 2%, up to about 3%, or up to about 10%, by weight of cement.

The process to make the composite may vary depending upon the desired characteristics of the composite, equipment available, and the materials to be employed. Generally, the process comprises mixing a reaction mixture comprising: (a) cement, and any other desired ingredients such as aggregates with (b) water which contained graphene already homogenized in it, for example via shear mixing. Alternatively, the solid ingredients including cement and graphene can be dry mixed, for example using ball mills, and then mixed with water in some embodiments. The mixture is typically cured by any convenient curing mechanism. The curing conditions such as moisture, temperature, and time may vary depending upon the ingredients of the composite and desired characteristics.

In some embodiments the dispersion of sheared graphene may include a surfactant in an amount to facilitate dispersion of the graphene in water. Such surfactants may vary depending upon the graphene and amount employed. However, typical surfactants may be a poloxamer such as poloxamer 407 (Pluronic® F-127)) or commercial household surfactants such as dishwasher surfactants (Fairy Liquid, Finish), If employed, the surfactant may be less than about 2%, or less than about 1.5%, or less than about 1% b weight based on the total weight of the sheared graphene and water dispersion. In some embodiments, the surfactant be used in shear exfoliation of graphene in water too.

In some embodiments, the surfactant is Pluronic F127, sodium cholate, Polystyrene sulfonic acid, Polyethylene imine, Sodium dodecyl sulfate, Sodium dodecyl benzene sulfate, Gum Arabic, Cetyltrimethylammonium bromide, Phosphate surfactants, Ammonium surfactants, Carboxylate surfactants, Amine surfactants, Phosphonate surfactants or non-ionic surfactants (such as TWEEN 20, TWEEN 40, TWEEN 60, TWEEN 80, TWEEN 85, Brij 93, Brij 5100, Brij 58, Brij L4, Brij C10, Brij 020, Brij 5100, Brij S20, IGEPAL CA-720, IGEPAL CO-520, IGEPAL CO-630, IGEPAL CO-720, IGEPAL CO-890, MERPOL HCS, MERPOL SE, MERPOL, SH, MERPOL A, Triton N-100, Triton X-100, Triton X-114, Triton X-405, Polyethylene glycol Mw=100 to 50,000 g/mol) or combination thereof.

The water to cement ratio is generally at least about 0.15, or at least about 0.17, or at least about 0.3, or at least about 0.4, or at least about 0.45, or at least about 0.5, or at least about 0.55, and up to about 0.7, or up to about 0.6, or up to about 0.5, or any ratios in between.

The graphene to water ratio is generally at least about 0.05 g/L, or at least about 0.10 g/L, or at least about 0.5 g/L, or at least about 0.7 g/L, or at least about 1 g/L, or at least about 2 g/L up to about 10 g/L, or up to about 8 g/L, or up to about 6 g/L, or up to about 5 g/L as well as all ratios in between.

The cement or concrete can have any typical additives such as, for example, plasticizers, retarders, air entrainers, foaming agents, etc as desired.

### Specific Embodiments and Examples

The present invention describes a novel technology utilizing the fundamentals of cutting-edge materials science, chemistry, advanced nano-engineering to create cementitious composites reinforced by various forms of carbon-based nanomaterials including mono, few and multi-layer graphene and/or quantum dots. Our results show that that even small loadings of carbon-based nanomaterials significantly enhance the physical properties of the composites (where the matrix can be cement, concrete, polymers, etc).

In some embodiments, our invention includes treatment of various graphene, graphite, and their sources (for example coal), and their mixture in cement/concrete, creating a rich library of measured composite properties.

In one embodiment, graphene (for example, obtained from various sources and method) was dispersed in water/Pluronic (F-127) solution (for example, 1%) at various concentrations (for example, from 1 to 10 g/L). The dispersion was agitated using shear mixer (Silverson L5MA) for 15 min at the speed of 5000 rpm. Next, the graphene suspension in water was mixed with Portland cement (type II/I) with water to cement ratio of 0.40. Next, the slurry was casted in 2″×2″×2″ PTFE cube molds (for compressive strength) and in 1″×1.5″ cylindered molds (for tensile strength). All cubes and cylinders were taken out of the molds after 24 hours and placed in water for curing. The compressive and tensile mechanical strength were measured after 7 and 28 days. For each graphene:cement ratio, 3 samples were casted and tested.

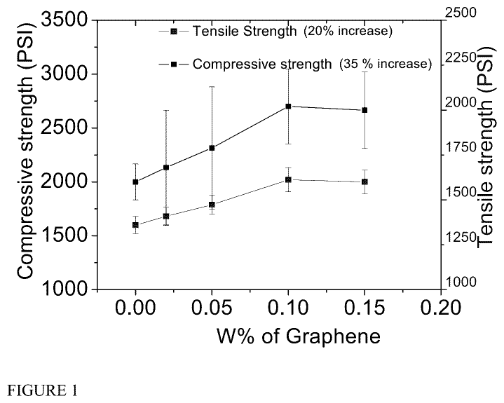

In one embodiment, the compression strength tests were performed using a Forney VFD (Variable Frequency Drive) automatic machine with dual load cells for maximum accuracy. The 7-day results indicate ˜35% increase compared to the control sample even with tiny fraction of 0.1% graphene by weight of cement (FIG. 1).

Due to brittle nature of cement-based materials, their tensile strength is usually obtained by indirect test methods such as the modulus of rupture test or splitting tensile test. We used the splitting test to measure the tensile strength of the cylinders. The specific jigs hold the cylinders so that the uniaxial compressive force applied to the center lines of the bottom and top surface of the samples causes the tensile stress between the points of contact (FIG. 1). The 7-day results indicate at least 20% increase in tensile strength compared to the control sample (free of graphene) with only 0.1% graphene

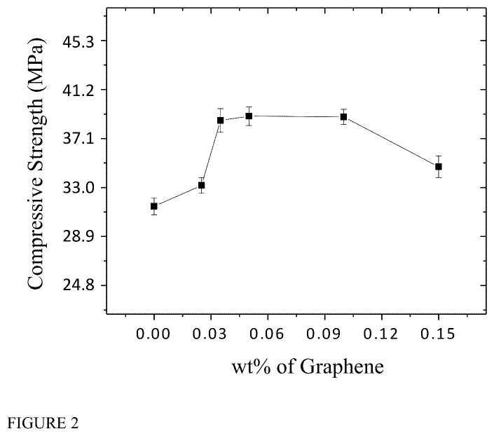

FIG. 2 shows the compressive strength of 2″ cement cubes after 28 days. The percentage increase in compressive strength (after 28 days) was 22.99% when the graphene amount was 0.035 w %. The percentage increase in compressive strength (after 28 days) was 25% when the amount of graphene was 0.05 w %. Comparison of 7 day and 28 day compressive strengths indicate that graphene loading lead to rapid strength development of cement-based materials as well.

The aforesaid large enhancement in the properties of graphene/cement composites is because of our synthesis method, which results in large dispensability of graphene and their extensive exfoliation in water where the homogenously distributed sheet-like graphenes act as templates to promote congruent growth of cement hydrate products. While not wishing to be bound to any particular theory it is believed that perhaps covalent C—O bonds/networks between graphene and cement hydrate products can change the hybridization of graphene from sp² to sp³ a upon covalent bond formation, greatly enhancing the properties of the composite. This change, along with electron release in the vicinity of their interfacial region, can lead to homogenous, inter-mixed and intercalated composites with improved properties.

The graphene used in this work can be mono and/or few layer graphene (<less than 10 layers), the layer stacking can be organized or disorganized or mixed, the layer stacking can be bernal (AB) stacking, randomly oriented stacking (turbostratic), or the combination thereof. Graphene used in this work can also be of different lateral dimensions, be nanoplatelets, or polyehedra, disoriented, misoriented, twisted, or any combination thereof. Turbostratic graphene has little to no order compared to conventional AB (bernal) stacking and may be easier to disperse in a solution.

The graphene in the above examples was turbostratic with mono and/or few layers, and obtained from carbon black, rubber tires, plastic waste derived pyrolysis ash, etc, as the raw material. However, the raw materials for the graphene used can be any source of carbon. The carbon feedstock can change the composite properties because the feedstock may play a role in the size and shape of the produced graphenes, and its quality (i.e. presence of defects) and thereby the composite properties.

The source of carbon can include but is not limited to any single or combination of the following: graphite, feces, plastics, vinyl polymers, condensation polymers, step-growth polymers, chain-growth polymers, living polymers, rubbers, humic acid, carbohydrates, rice powder, food waste, food, coal, organic waste, organic material, bituminous coal, coke, shungite, asphaltenes, acetylene black, carbon black, petroleum coke, oil, petroleum products, carbon from the stripping of the non-carbon atoms off of natural gas or oil or carbon dioxide, wood, cellulose, leaves, branches, grass, biomass, animal carcasses, fish carcasses, proteins, and mixtures thereof. The type of coal is not particularly limited and includes, for example, a coal selected from anthracite, bituminous, sub-bituminous, lignite, or a mixture thereof. Similarly, the type of plastic is not limited and includes, for example, a plastic selected from high-density polyethylene (HDPE), low-density polyethylene (LDPE), polyvinyl chloride (PVC), polypropylene (PP), polyacrylonitrile (PAN), Polyethylene terephthalate (PET), or a mixture thereof.

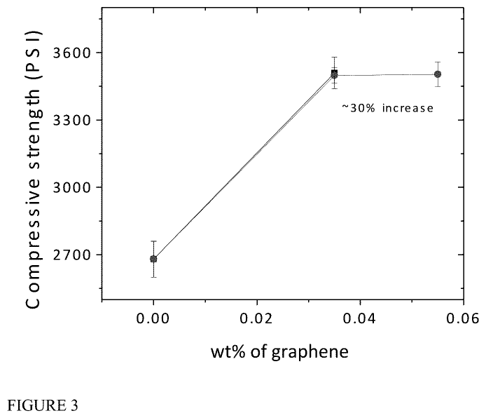

In another embodiment, we tested graphene made from HDPE, or PP or mixture of the two. Similar to the previously mentioned synthesis method, cement composites from HDPE and PP mixture were tested. It was found that addition of at least 0.035% of HDPE-derived graphene can increase the compressive strength of Portland cement by 30% (FIG. 3). Here, the graphene may be sheared in water at a concentration of 0.5, or 0.7, or 1.0 or 1.5 g/L with a suitable amount of a suitable surfactant. In that vein, 0.025, or 0.05, or 0.1, or 0.2 or more wt % of sodium cholate or a Pluronic® may be useful as a surfactant.

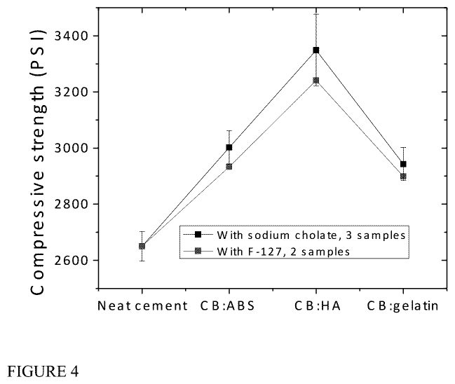

In another embodiment, we created 2″ cement cubes reinforced with turbostratic graphene made from a mixture of each of carbon black:acrylonitrile Butadine Styrene (5%:95% weight ratio), hereto called CB:ABS, or carbon black:gelatin (5%:95% weight ratio), hereto called CB:Gelatin, or carbon black:humic acid (5%:95% weight ratio), hereto called CB:gelatin. Here, the graphene may be sheared in water at a suitable concentration of surfactant, e.g., from 0.1 to about 1.5 g/L, e.g., 0.7 g/L with sodium cholate or Pluronic F-127 as a surfactant. The 7-day compressive strength results are shown in FIG. 4. The cement samples with CB:HA fillers show >27% increase in compressive strength.

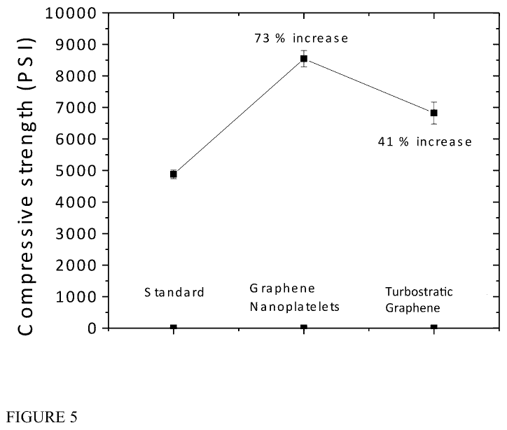

In another embodiment, we created concrete samples. First, turbosratic graphene may be shear mixed for a suitable time at a suitable temperature (10, or 15, or 20, or 25 min at the speed of 3000, or 4000, or 5000 rpm) in water at e.g., from 0.1 to about 1.5 g/L, e.g., 0.7 g/L with 0.025, or 0.05, or 0.075 wt % of a Pluronic® or sodium cholate as a surfactant. Next, the graphene suspension in water was mixed with Portland cement (type II/I) with water to cement ratio of 0.57, to which we added sand and gravel at the following ratio, cement:sand:gravel 1:2:3. Next, the mixture was casted in 4″×8″ molds. All cylinders were taken out of the molds after 24 hours and placed in water for curing. The compressive and tensile mechanical strength were measured after 7 and 28 days. For each graphene:cement ratio, 3 samples were casted and tested. FIG. 5 shows representative results, demonstrating >41% increase with respect to the control concrete sample free of graphene. By repeating the above procedure using commercial graphene nanoplatelets (in lieu of turbostratic graphene), we obtained >73% increase in compressive strength after 28 days.

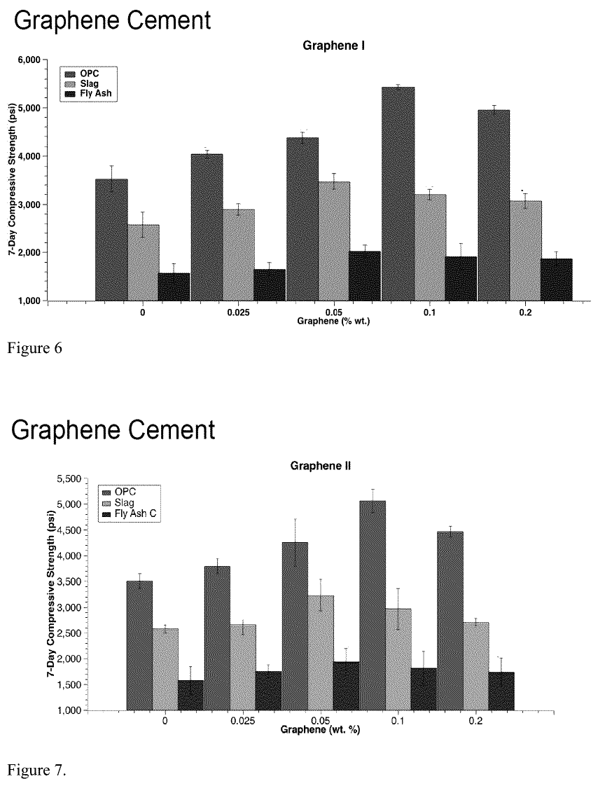

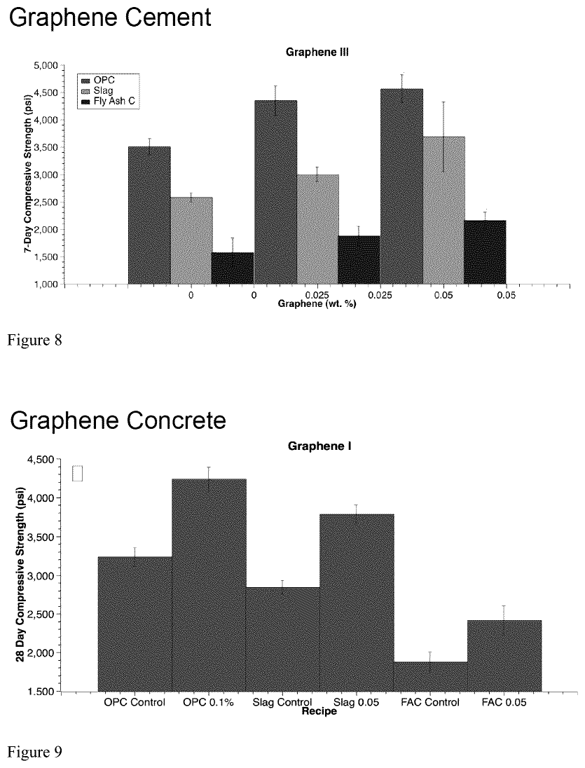

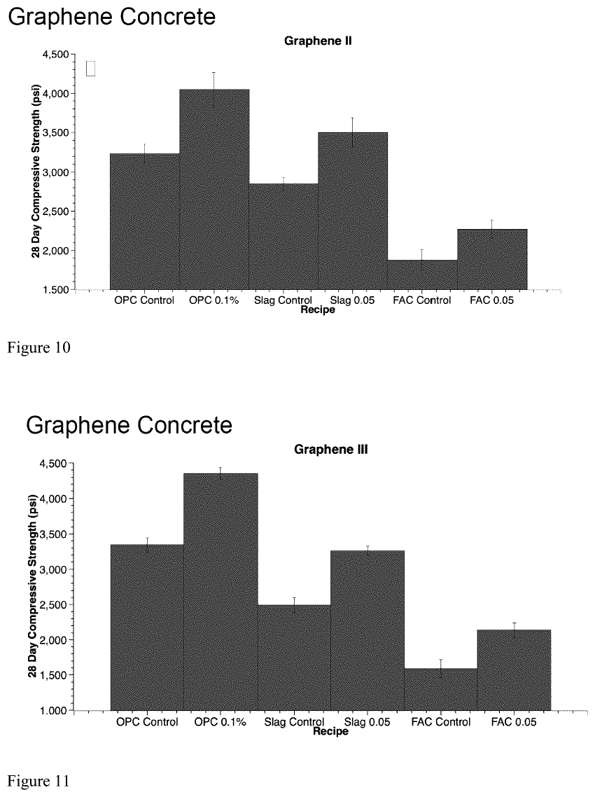

In some embodiment, small amounts of three types of turbostratic graphene obtained from carbon black derived from pyrolyzed rubber tires (hereto called graphene I), from waste plastics derived pyrolysis ash (hereto called graphene II) and shredded raw rubber tires (hereto called graphene III) were sheared mixed (as described earlier) in water. Next, each solution was added to ordinary Portland cement (OPC), flyash C, and Slag and each cured for 7 days to yield 1″ cube composite pastes (FIGS. 6 to 8). In other experiments, we included sand and gravel to these paste mixtures to create 4×8″ concrete cylinders (FIGS. 9 to 11). Significant increases in compressive strength were observed in all cases, with strength increasing as content of turbostratic graphene increases, reaching an optimal loading between 0.05 to 0.2%. For example, the compressive strength enhancement of at least 15% was measured for 0.1% enhanced OPC paste, and a 15% increase was observed for OPC concrete. The data for concrete are only shown for an optimal wt % of the specific graphene in the specific cement.

In some embodiments, the feedstock of graphene II (or generally carbon feedstocks that have low electrical conductivity) had between 0 to 10% conductive materials such as commercial carbon black, metals, or graphene.

In some embodiments, the average sheet size of graphene I, II, III was around 200-300 nm containing around 10-15 sheets stacked.

In some embodiment, the shrinkage of the above composite pastes and concrete reinforced with graphene I, II, and III were at least 10% lower compared to the samples without I, II, and III as measured by average changes in the cross-sections of the samples.

The graphene used in the above example can be manufactured with various methods including but not limited to various top-down approaches such as direct sonication of graphite, chemical exfoliation of graphite, micromechanical exfoliation, electrochemical exfoliation, super acid dissolution of graphite, electrographitization, etc, and various bottom-up approaches such as chemical vapor deposition (CVD), epitaxial growth, arch discharge, joule heating, flash joule heating, pyrolysis, unzipping of carbon nanotubes, confined self-assembly, reduction of CO, one-step or multiplestep non-dispersion methods of producing graphene, etc.

This invention can be applied to less than or more than 10 layers of graphene. Graphene with more than 10 layers is often times called graphite, thus the invention can also be applied to chemically expanded graphite or thermally expanded graphite (TEG), non-planar graphite, etc.

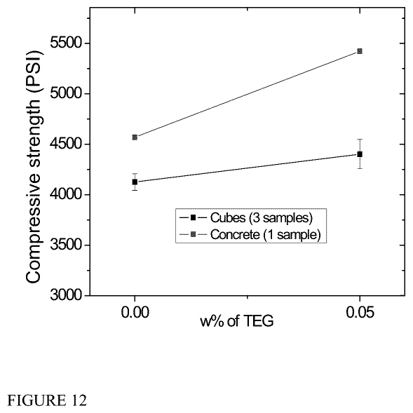

In one embodiment, we created cement and concrete samples reinforced by thermally expanded graphite (TEG). First, TEG was shear mixed (15 min at the speed of 5000 rpm) in water using sodium cholate as a surfactant. Next, the TEG suspension in water was mixed with Portland cement (type II/I) with water to cement ratio of 0.4. Next, the mixtures were casted in 2″ molds. For creating concrete samples, we added sand and gravel to the cement slurry at the following ratio, cement:sand:gravel 1:2:3. All cement cubes and concrete cylinders were taken out of the molds after 24 hours and placed in water for curing. The mechanical strength were measured after 7 and 28 days. FIG. 12 shows representative 28 day results, demonstrating >20% increase in compressive strength of concrete samples with respect to the control concrete sample.

The present invention can be used with or without surfactants. In one embodiment, graphene (obtained from various sources) was dispersed in only water at various concentrations, for example, from 1 to 10 g/L. In another embodiment, the amount of surfactants can be decreased or increased to tune the composite properties. In another embodiment, the surfactant can be household detergents such as Fairy washing-up liquid (commonly known as Fairy Liquid, FL), a common household dishwashing liquid, with a composition of 15-30% anionic surfactants, 5-15% nonionic surfactants.

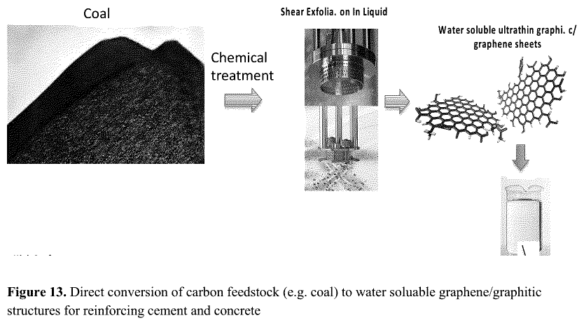

In some embodiments, we bypassed the use of graphene manufactured by top-down or bottom-up approaches such as those derived from arch discharge, exfoliation from graphite, joule heating, flash joule heating, etc. Instead, we turned various carbon feedstocks (for example, coal) “directly” to carbon-based nanomaterials with quantum-dot and/or graphene/graphitic structures. This direct conversion of carbon feedstock to carbon-based nanomaterials for cementitious materials in shown in FIG. 13.

In some embodiments, we focused on coal as a source of carbon and in some embodiments we oxidized the coal using a suitable oxidizing agent such as nitric acid, sulfuric acid, or potassium permanganate followed by homogenization in water using a suitable mixer such as a Banbury mixer, a shear mixer, a Haake mixer, a Brabender mixer, a sonicator, or a rotor-stator, jet mill or a Gaulin homogenizer.

In some embodiments, the oxidizing agent can be from KMnO4, HNO3, KClO3, H2SO4, HCl, H3PO4, KNO3, NaNO3, or chromates (such as (NH4)2Cr2O7, CrO3, Bis(tetrabutylammonium) dichromate, K2Cr2O7, Pyridinium chlorochromate, (C5H5N)2. H2Cr2O7, Na2Cr2O7, Na2Cr2O7.2H2O, peroxides (H2O2, CaO2, C14H10O4, C8H18 O6, C4H10O2, C9H12O2, C18H22O2, CH4N2O·H2O2, Li2O2, C10H14O6, C8H18O2, C24H46O4, NiO2, NiO2·xH2O, Na2O2, SrO2, ZnO2) or Peroxy acids and salts (such as C11H21BF4N2O2, C7H5ClO3, C16H10MgO10·6H2O, C2H4O3) or sulfur-based oxi dizing agents (such as (NH4)2S2O8, HKO5S·0.5HKO4S·0.5K2O4S, K2NO7S2, K2O8S 2, Na2O8S2, C3H7NO4S, C5H5NO3S, C6H15NO3S, C3H9NO3S, Cl2H27NO3S) or h ypervalent iodines (C13H8Br2F31O3S, C16H23IO4, C13H8F5IO3S, C15H14F3IO3S, C 10H10BF4IN2, C10H10BF4IN2, C10F11IO4, C16H15BrF3IO3S, C13H13IO8, C13H13 IO8, Cl2H10ClI, C13H13IO4S, C7H5IO4, C8H5IO6, C8H5IO6, C16H15F3INO5S, H5 IO6, C14H9F6IO3S, C7H6IKO3S, IKO4, INaO4, H2INa3O6, C8H2O1NO4) or Hypochl orites (Ca(Ocl)2, NaOCl) or osmium-based oxidizing agents (OSO₄, K2OsO4·2H2O, Pe rchlorates, Al(ClO4)3·9H2O, Ba(ClO4)2, Cd(ClO4)2.4H2O, Cd(ClO4)2·xH2O, CsClO4, Cu(ClO4)2·6H2O, C17H26N3O2S·ClO4, C13InO12 xH2O, Cl3FeO12 xH2O, Cl2O 8Pb·xH2O, Cl2O8Pb·3H2O, LiClO4, LiClO4·3H2O, MgClO4, Mn(ClO4)2·xH2O, Hg(ClO4)2·xH2O, Ni(ClO4)2·6H2O, HClO4, DClO4, KClO4, Sc(ClO4)3, AgClO4·3H2 O, AgClO4.1H2O, AgClO4·xH2O, NaClO4, NaClO4·H2O, C16H36ClNO4, Zn(ClO4)2·6H2O) or other oxidizing agents such as H8CeN8O18, H12Mo12N3O40P·xH2O, C9H1 4NO, C36H30CrO4Si2, ClOH15NS, C7H7CINNaO2S·3H2O, C7H7CINNaO2S·xH2O, C6Cl4O2, C6H5Cl NNaO2S·xH2O, C8Cl2N2O2, C4H5ClO3, C11H11NO, C8HCl4NO3, C8H12NO2, MgMn2O8·xH2O, C3H3ClO3, C5H11NO2, BF4NO, C2Br2O2, C2Cl2O2, H2Mo12O40P·xH2O, KO4Ru, O2Se, C2Cl2N3NaO3, C3Cl2N3NaO3·2H2O, MnNaO4·H2O, MnNaO4, CNa2O3·1.5H2O, Mo12Na3O4OP·xH2O, C9H18NO, C6N4, C21H28 NO4Ru, C3H9NO3S, C3H9NO·2H2O, or the combination thereof.

In some embodiments, our invention allows up to full control over various ranks of coal, and the homogeneity and water solubility of the carbon product.

In some embodiments, first, a desired amount of coal feedstock is added into water with a suitable amount of oxidizing agent. Oxidizing agents include, for example, acids such as nitric acid, sulfuric acid, and mixtures of sodium or potassium permanganates with, for example, peroxides like hydrogen peroxide. For example, a suitable volume percent of potassium permanganate, e.g., less than 10v % such as 5v % or 6v %, or 7v %, or 8v % of Potassium permanganate can be mixed with hydrogen peroxide in a suitable ratio, e.g., (2:1 or 1:2 or 1:1). After stirring for a desired time (e.g. 1 h, 2 h, 3 h) at a desired temperature (25° C., 50° C., 100° C., 150° C., 200° C.) the solution was decanted and centrifuged to get all the solids. Second, the solid product was suspended in water at a concentration of ˜0.2-2 g/L (depending on the coal feedstock), followed by high shear mixing for 10 min at 10000 rpm. This water solution that contains carbon-based materials was supplied with optimal ratios to cement to make cementitious binders or, to a mixture of cement, sand, and gravel to make concrete. Alternatively, this solution was supplied as an additive with optimal ratios to a mixture of cement and water to make cementitious binders or, a mixture of cement, water, sand, and gravel to make concrete. The whole mixture can be mixed on job sites using conventional cement and concrete mixers or the like.

In some embodiments, Potassium permanganate (KMnO4) and hydrogen peroxide (H₂O₂) can be mixed in a suitable ratio, e.g., 2:1 or 1.5:1 or 1:2 or 1:1.5 or 1:1. The stock solution is transferred into 50 L of water with a suitable concentration, for example, lv %, or 3v %, or 5v %, or 7v %, or 10v % of KMnO₄/H₂O₂. Next, a desired amount of feedstock (˜1 kg of coke) was added into the 50 L of oxidant solution. The solution was stirred for a desired time (e.g. 1 h, 2 h, 3 h) at a desired temperature (25° C., 50° C., 100° C., 150° C., 200° C.). Then, the solution was filtered using centrifuge to get the solid carbon product. Next, this solid product was suspended in 5 L water at a concentration between −0.2 to ˜1.7 g/L, followed by shear mixing for 10 min at a speed of 10000 rpm. Generally the suspension has a range of carbon-based nanomaterials such as quantum dots and/or graphene/graphitic-like sheets with different thicknesses, lateral sizes and defects. The suspension was used to cast 2″ cement cubes with water to cement ratio (w/c) of 0.57 (or lower) using Portland cement types II. To create concrete samples, we added sand and gravel to the cement mixture with cement:sand:gravel ratio of 1:2:3 (with w/c=0.57) and casted 4″×8″ concrete cylinders. After 24 hrs, the samples were removed out of the mold and immersed in water for curing up to 7 and 28 days. As a reference, graphite as a layered feedstock may be employed with or without chemical treatment. In some cases a Sodium cholate surfactant may be employed to make it more dispersible in water, followed by similar shear blending. We also can use industrial grade graphene nanoplatelets as feedstock and shear blend it in water.

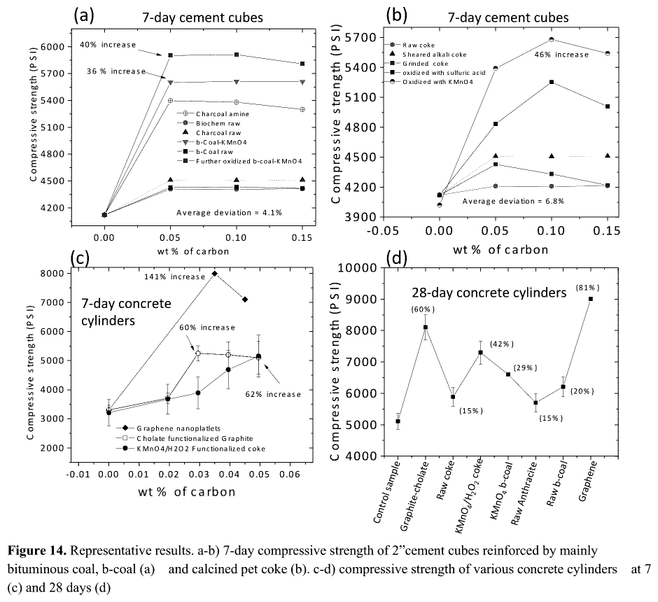

FIG. 14a-b show the compressive strength of 2″ cement cubes reinforced by mainly bituminous coal, b-coal, (FIG. 14a) and calcined coke (FIG. 14b) at 7 days. FIG. 14c-d show the compressive strength of 4″×8″ concrete cylinders at 7 day (FIG. 14c) and 28 days (FIG. 14d). In FIG. 14d, the data is shown for the optimum wt % of carbon in cement. Interestingly, graphene represents the most increase in strength of concrete in both 7 and 28 days, reaching 141% and 81% with only ˜0.035 wt % of weight of cement (tiny fraction). Second to graphene, coke functionalized via KMnO4/H2O2, demonstrated 62% and 42% increase in strength at 7 days and 28 days, respectively with only 0.05 wt % of coke in cement (again a very tiny fraction). In both cases, the 28 day strength is lower than 7 day strength, suggesting more contribution of such carbon-based nanomaterials to early strength development. However, the increase in strength after 28 days is still quite encouraging given the very low wt % of the fillers. To our knowledge, there is no any other report for such increase in strength with these low wt % of coal-derived carbon nanomaterials directly used in cement composites.

Remarkably, other coal-derived carbon materials (bituminous coal, graphite) also contribute significantly (>35%) to the mechanical properties with similarly low wt %. This will have important implication on best utilization of coals at different geographies. Note that addition of raw coals (bituminous, coke, etc), even if shear blended at high rpm or grinded, did not help and in many instances chemical treatment is needed. Similarly, the chemical treatment alone in many cases does not yield good results and its combination with the shear blending is necessary. Our synthesis method, along with various wt % of carbon-based nanomaterials (for example quantum dots, graphene/graphitic structures, etc) will also lead to increases in other composite properties such as lower shrinkage, enhanced tensile strength, modified viscosity, higher thermal and electrical properties and durability of cementitious materials. Such property enhancement at these low weight fractions of carbon-based nanomaterials and using inexpensive feedstocks is unprecedented.

In some embodiments, we used various treatments such as oxidization (with sulphuric acid, KMnO4), further oxidization, ball-milling, etc, and various feedstocks such as charcoal, biochar, biochem, etc as shown in FIG. 14.

In some embodiments, the weight percentage of the carbon-based nanomaterials in the cement may be much larger and the various properties may be optimized further.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

The present invention has applications in several areas including (but not limited to) general cement and concrete industry, roads, building, pedestrian ways, glass fiber reinforced concrete, application for extreme conditions including but not limited to well cementing for oil and gas extraction or geothermal wells, cement used in nuclear industry, cement used in army and military applications as well as for airport infrastructures and runways, and other applications of cementitious composites.

What is claimed is:

1. A cementitious composite binder composition comprising
at least about 99% binder by weight based on the total weight of the composition; and
at least about 0.001% by weight carbon based nanomaterial based on the total weight of the composition;
wherein a composite made from the composition is characterized by
(a) a compressive strength of at least about 15% greater than a compressive strength of the same composite made without the carbon based nanomaterial; or
(b) a tensile strength of at least about 15% greater than a tensile strength of the same composite made without the carbon based nanomaterial; or
(c) both (a) and (b).

2. The cementitious composite binder composition of claim 1, wherein the carbon based nanomaterial comprises less than 10 layers.

3. The cementitious composite binder composition of claim 1, wherein the carbon based nanomaterial comprises more than 10 layers.

4. The cementitious composite binder composition of claim 1, wherein the carbon based nanomaterial comprises turbostratic graphene.

5. The cementitious composite binder composition of claim 1, wherein the carbon based nanomaterial comprises bernal stacked graphene.

6. The cementitious composite binder composition of claim 1, wherein the carbon based nanomaterial comprises nanoplatelets.

7. The cementitious composite binder composition of claim 1, wherein the carbon based nanomaterial is derived from a coal selected from anthracite, bituminous, sub-bituminous, lignite, or a mixture thereof carbon black; calcined petroleum coke; charcoal; or a mixture thereof.

8. The cementitious composite binder composition of claim 1, wherein the carbon based nanomaterial is oxidized.

9. The cementitious composite binder composition of claim 1, wherein the carbon based nanomaterial is turbostratic graphene derived from any single or combination of the following: graphite, feces, a plastic selected from shigh-density polyethylene (HDPE), low-density polyethylene (LDPE), polyvinyl chloride (PVC), polypropylene (PP), polyacrylonitrile (PAN), Polyethylene terephthalate (PET), or a mixture thereof, vinyl polymers, condensation polymers, step-growth polymers, chain-growth polymers, living polymers, rubbers, humic acid, carbohydrates, rice powder, food waste, food, coal, organic waste, organic material, bituminous coal, coke, shungite, asphaltenes, acetylene black, carbon black, petroleum coke, oil, petroleum products, carbon from the stripping of the non-carbon atoms off of natural gas or oil or carbon dioxide, wood, cellulose, leaves, branches, grass, biomass, animal carcasses, fish carcasses, proteins, and mixtures thereof.

10. The cementitious composite binder composition of claim 1, wherein a composite made from the composition is characterized by
(a) a compressive strength of at least about 15% greater than a compressive strength of the same composite made without the carbon based nanomaterial; or
(b) a tensile strength of at least about 15% greater than a tensile strength of the same composite made without carbon based nanomaterial; or
(c) both (a) and (b).

11. The cementitious composite binder composition of claim 1, wherein a composite made from the composition is characterized by at least a 10% increase in thermal conductivity, electrical conductivity, Young modulus, or durability and at least 5% decreased shrinkage than the same composite made without the carbon based nanomaterial.

12. The cementitious composite binder composition of claim 1, wherein the composition comprises from about 0.001% to about 10% by weight of the carbon based nanomaterial based on the total weight of the binder composition.

13. The method of claim 1 wherein the carbon based nanomaterial is functionalized with one or more atoms selected from a group consisting of oxygen, carbon, metals, sulfur, phosphorous, non-metals, metalloids, and combinations thereof.

14. A method for making a composite comprising:
mixing a reaction mixture comprising: (a) a dry cement or concrete ingredients and (b) a dispersion of sheared carbon based nanomaterial and water; and
curing said mixture to form a composite.

15. The method of claim 14, further comprising oxidizing the carbon based nanomaterial.

16. The method claim 15, wherein the carbon based nanomaterial is oxidized prior to or simultaneous with shearing the carbon based nanomaterial.

17. The method of claim 15, wherein the carbon based nanomaterial is oxidized with a mixture of KMNO4 and H2O2.

18. The method of claim 17, wherein the ratio of KMNO4 to H₂O₂ is from about 1:2 to about 2:1.

19. The method of claim 15, wherein the composite is characterized by
(a) a compressive strength of at least about 15% greater than a compressive strength of the same composite made without the carbon based nanomaterial; or
(b) a tensile strength of at least about 15% greater than a tensile strength of the same composite made without the carbon based nanomaterial; or
(c) both (a) and (b).

20. A method for making a concrete composite having increased strength comprising:
mixing (a) a dry concrete ingredient comprising a sheared carbon based nanomaterial and (b) water; an (c) aggregates; and
curing said mixture to form a concrete composite.
